(19) United States
(12) Patent Application Publication
(10) Pub. No.: US 2026/0029643 A1
(43) Pub. Date: Jan. 29, 2026

(54) HEAD-UP DISPLAY APPARATUS

(71) Applicant: Yazaki Corporation, Tokyo (JP)

(72) Inventors: Hiroshi SANO, Makinohara-shi (JP); Noriaki Narushima, Makinohara-shi (JP); Yoshihide Takada, Makinohara-shi (JP)

(73) Assignee: Yazaki Corporation, Tokyo (JP)

(21) Appl. No.: 19/249,341

(22) Filed: Jun. 25, 2025

(30) Foreign Application Priority Data
Jul. 26, 2024 (JP) 2024-120725

(51) Int. Cl. G02B 27/01; G02B 5/10

(52) U.S. Cl. CPC G02B 27/0101; G02B 5/10

(57) ABSTRACT

A HUD apparatus includes a display device, a first mirror, a second mirror, a housing, a cover, an inner case, and a bezel with light-shielding wall. The bezel with light-shielding wall is attached to an upper end portion of the first mirror. The bezel with light-shielding wall shields any external light entering the housing from the opening portion and prevents the generation of any unexpected reflections on the windshield. Also, by attaching the first mirror to the bezel with light-shielding wall, the reflection range on the first mirror is suppressed to the minimum necessary, and the display light leaking out of the optical path for the virtual image display is not reflected by the first mirror such that it is possible to prevent the generation of any stray light.

### TECHNICAL FIELD

The present invention relates to a head-up display apparatus.

### BACKGROUND ART

A head-up display apparatus that is mounted in a vehicle and configured to display the vehicle driving information and the like as a virtual image to a driver thereof at a front side of a windshield (outside the vehicle) by projecting the light from a display device on the windshield is known.

FIG. 3 is a schematic view showing a conventional head-up display apparatus 510 (see Patent Document 1). The head-up display apparatus 510 includes a light source 511, a display device 513, a first concave mirror 514 reflecting display light 512 emitted from the display device 513, a second concave mirror 516 reflecting display light 515 that is reflected at the first concave mirror 514, and a case 520.

The first concave mirror 514 has a curvature (the reciprocal of the radius) to make the reflected display light 515 to be crossed in the up-down direction before reaching the second concave mirror 516.

The case 520 includes a first shielding portion 523 and a second shielding portion 524 so as to sandwich an optical path 521 between the first concave mirror 514 and the second concave mirror 516 while extending to a vicinity of a cross point 522 where the display light is crossed. In the first shielding portion 523 and the second shielding portion 524, an anti-reflection coating 527 is formed to reduce or prevent the reflection of any external light 525.

For such head-up display apparatus 510, it is possible to shield the external light 525 intruding the case 520 from the outside of the case 520 to be reflected on the second concave mirror 516 and redirected toward the first concave mirror 514 by the first shielding portion 523 and the second shielding portion 524.

### CITATION LIST

### Patent Documents

[Patent Document 1] JP 6579319B

### SUMMARY OF THE INVENTION

### Technical Problem

Since the conventional head-up display apparatus 510 is provided with the first shielding portion 523 and the second shielding portion 524 in the case 520, it leads to a problem that the inside of the case 520 becomes a complicated labyrinth structure and it is difficult to dispose members such as a mirror or the like in the case 520.

The present invention is made for achieving the goal of providing a head-up display apparatus where it is easy to dispose the member such as the mirror or the like in the housing while being able to shield the external light.

### Solution to Problem

The present invention is a head-up display apparatus comprising a display device; a first mirror reflecting display light emitted from the display device; a second mirror reflecting the display light being reflected by the first mirror; and a housing accommodating the display device, the first mirror, and the second mirror, characterized in that the first mirror is a configuration to make the display light to be crossed in an up-down direction before reaching the second mirror, and a member having a light-shielding wall is attached to at least one of the first mirror or the second mirror.

### Effect of the Invention

According to the present invention, it is possible to provide a head-up display apparatus where it is easy to dispose the member such as the mirror or the like in the housing while being able to shield the external light.

### BRIEF DESCRIPTION OF THE DRAWINGS

FIG. 1 is a schematic view showing a head-up display apparatus according to an embodiment of the present invention.

FIG. 2 is an enlarged view showing a portion that is enclosed by the dashed line in

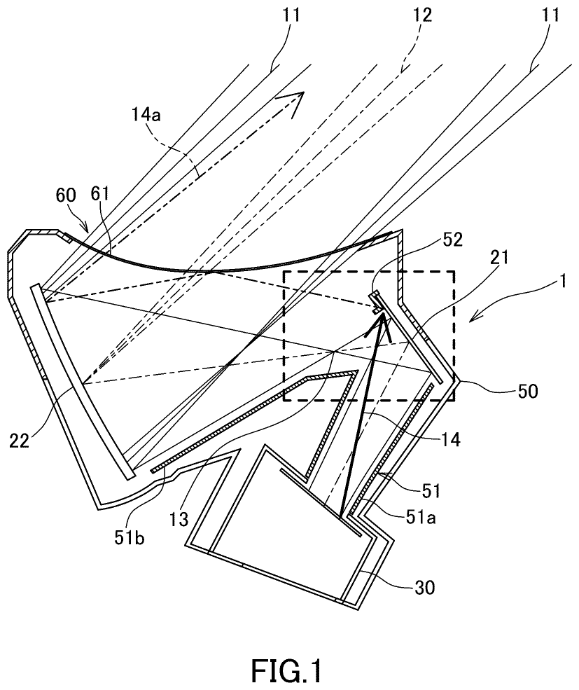

FIG. 1.

FIG. 3 is a schematic view showing a conventional head-up display apparatus.

### DESCRIPTION OF EMBODIMENTS

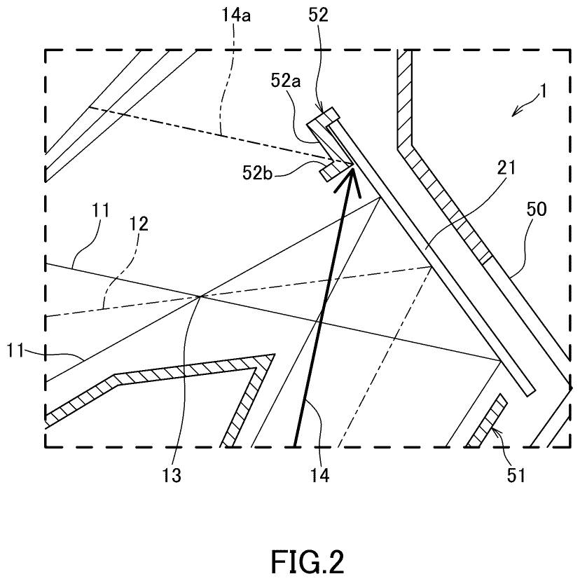

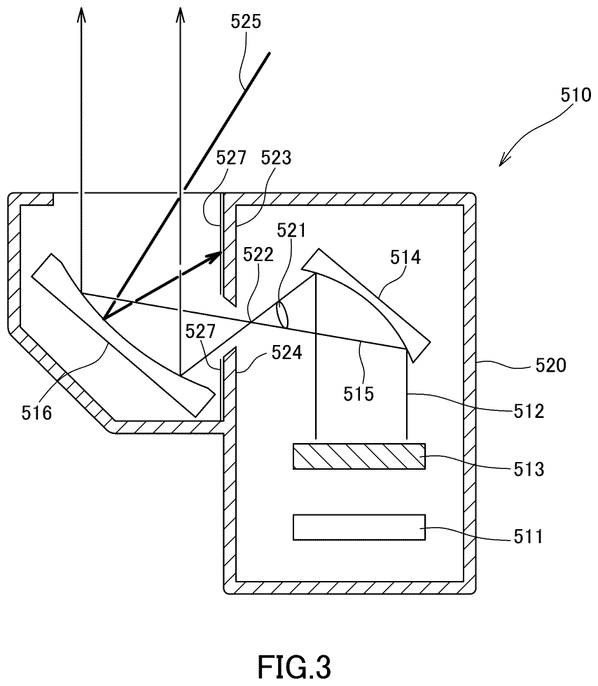

A “head-up display apparatus” according to an embodiment of the present invention will be described by referring to FIG. 1 and FIG. 2. FIG. 1 is a schematic view showing a head-up display apparatus (hereinafter referred to as a “HUD apparatus”) 1 according to an embodiment of the present invention. FIG. 2 is an enlarged view showing a portion that is enclosed by the dashed line in FIG. 1.

The HUD apparatus 1 is a configuration accommodated inside an instrument panel of a vehicle and configured to display the vehicle driving information and the like as a virtual image to a driver thereof at the front side of a windshield (outside the vehicle) by projecting the display light on the windshield.

As shown in FIG. 1, the HUD apparatus 1 includes a display device 30, a first mirror 21, a second mirror 22, a housing 50, a cover 61, an inner case 51, and a bezel with light-shielding wall 52. The reference sign 11 in FIG. 1 shows an optical path, and the reference sign 12 is an optical axis.

The display device 30 is a configuration emitting the display light, and for example, can be adopted as a liquid crystal display. The display device 30 emits the display light toward the first mirror 21.

The first mirror 21 is a configuration reflecting the display light emitted from the display device 30 to the second mirror 22 side. Also, the first mirror 21 has a curvature to make the reflected display light to be crossed in the up-down direction before reaching the second mirror 22. The reference sign 13 in FIG. 1 is a cross point.

The second mirror 22 is a configuration reflecting the display light that is reflected by the first mirror 21 to the windshield side.

The housing 50 is a configuration accommodating the display device 30, the first mirror 21, the second mirror 22, the inner case 51, and a bezel with light-shielding wall 52. The housing 50 is made of the light-shielding synthetic resin black or other color. In the housing 50, an opening portion 60 is formed to allow the display light reflected on the second mirror 22 to the outside.

The cover 61 is a configuration blocking the opening portion 60. The cover 61 is made of the translucent synthetic resin. The display light reflected on the second mirror 22 transmits through the cover 61 to be projected on the windshield. Then, the display light reflected at the windshield is directed toward the eyes of the driver in the driver's seat. The driver recognizes the display light that enters the eyes thereof as the virtual image displayed at the front side of the windshield (outside the vehicle).

The inner case 51 is made of a light-shielding member in the black or other color. The inner case 51 has a cylindrical portion 51a disposed between the display device 30 and the first mirror 21, and a plate portion 51b disposed immediately below the opening portion 60 while being at a position not to block the display light reflected from the first mirror 21 to the second mirror 22. The inner case 51 shields the external light entering the housing 50 through the opening portion 60, and prevents any unexpected reflections on the windshield.

The bezel with light-shielding wall 52 is made of a light-shielding member in the black or other color. The bezel with light-shielding wall 52 is attached to an upper end portion of the first mirror 21. The bezel with light-shielding wall 52, as shown in FIG. 2, includes an attachment portion 52a being attached to the first mirror 21, and a light-shielding wall 52b projecting from the reflection surface of the first mirror 21 to the second mirror 22 side.

The above-described bezel with light-shielding wall 52 shields the external light entering the housing 50 through the opening portion 60, and prevents any unexpected reflections on the windshield. Also, by attaching the bezel with light-shielding wall 52 to the first mirror 21, the reflection range on the first mirror 21 is suppressed to the minimum necessary, and the display light 14 leaking out of the optical path 11 for the virtual image display is not reflected by the first mirror 21 (the display light 14 is absorbed by the bezel with light-shielding wall 52). Accordingly, it is possible to prevent the generation of any stray light.

In addition, the dotted line 14a in FIG. 1 and FIG. 2 represents the stray light that is generated when the display light 14 leaks out of the optical path 11 of the virtual image display and is reflected by the first mirror 21 when the bezel with light-shielding wall 52 is not attached to the first mirror 21.

According to such HUD apparatus 1, when compared with the conventional head-up display apparatus 510, it is possible to realize the shielding of the external light in the state when there is no light-shielding wall in the housing 50. The conventional head-up display apparatus 510 is in a complicated labyrinth structure inside the case 520 since the case 520 is provided with the first shielding portion 523 and the second shielding portion 524, and thus there is a problem that it is difficult to dispose members such as a mirror or the like in the case 520. Compared with such configuration, the HUD apparatus 1 realizes the light shielding of the external light by the bezel with light-shielding wall 52 attached to the first mirror 21 and the inner case 51, the above-mentioned problem does not occur, and it is easy to perform the assembling. Also, a spare space in the vicinity of the cross point 13 can be secured such that it is possible to miniaturize HUD apparatus 1.

According to the above-described embodiment, the bezel with light-shielding wall 52 is attached to the first mirror 21, however, in the scope of the present invention, the member having the light-shielding wall only has to be attached to at least one of the first mirror or the second mirror.

Also, according to the above-described embodiment, the bezel with light-shielding wall 52 is described as the “member having the light-shielding wall”, however, the “member having the light-shielding wall” is not limited to the bezel, for example, the masking tape, the elastic member, a clip device or the like may be adopted. For example, depending on the adopted member, such as the clip device, the labor required for the assembly can be reduced, which is expected to improve the ease of assembly.

It is noted that the above-described embodiment merely shows a typical aspect of the present invention, and the present invention is not limited to this embodiment. That is, various modifications can be made without departing from the scope of the invention. Of course, such modifications will fall within the scope of the present invention as long as they still have the configurations according to the present invention.

### REFERENCE SIGNS LIST

1 head-up display apparatus
21 first mirror
22 second mirror
30 display device
50 housing
51 inner case
52 bezel with light-shielding wall
52b light-shielding wall

What is claimed is:

1. A head-up display apparatus, comprising:
a display device;
a first mirror reflecting display light emitted from the display device;
a second mirror reflecting the display light being reflected by the first mirror; and
a housing accommodating the display device, the first mirror, and the second mirror,
wherein the first mirror is a configuration to make the display light to be crossed in an up-down direction before reaching the second mirror, and
a member having a light-shielding wall is attached to at least one of the first mirror or the second mirror.

2. The head-up display apparatus according to claim 1, wherein the member having the light-shielding wall is attached to an upper end portion of the first mirror.

3. The head-up display apparatus according to claim 1, further comprising an inner case accommodated in the housing,
wherein the inner case is made of a light-shielding member and disposed on a position where the display light reflected from the first mirror to the second mirror is not shielded.
